(19) United States
(12) Patent Application Publication
(10) Pub. No.: US 2010/0059595 A1
(43) Pub. Date: Mar. 11, 2010

(54) RADIO FREQUENCY IDENTIFICATION LABEL

(76) Inventor: Chuang Longfu, Taipei City (TW)

Correspondence Address: YH Chan, 42 Pin Oaks Drive, Phoenixville, PA, 19460, US

(21) Appl. No.: 12/477,144

(22) Filed: Jun. 3, 2009

(30) Foreign Application Priority Data
Sep. 9, 2008 (CN) 200820147376.5

(51) Int. Cl. G06K 19/02; G06K 19/06

(52) U.S. Cl. 235/488; 235/492

(57) ABSTRACT

A radio frequency identification (RFID) label for a product includes a protective structure configured to be attached to the product, and an electronic tab wrapped in the protective structure.

### BACKGROUND OF THE INVENTION

The present disclosure relates to identification, and particularly to a radio frequency identification (RFID) label.

RFID labels are not connected to batteries, while depend on electromagnetic energy transmitted by readers to work. The RFID labels are widely used in many fields, because of simple structures and low costs. However, the RFID labels are often used in shapes of paster, labeling, scutcheon, and so on, to be fixed to products. Therefore, the RFID labels are too easily be damaged to possess functions of logistics management, anti-fake, and prevention of theft, especially for textiles including cloths, caps, shoes, and socks, and also for cases and bags.

### BRIEF SUMMARY OF THE INVENTION

An exemplary A radio frequency identification (RFID) label for a product includes a protective structure configured to be attached to the product, and an electronic tab wrapped in the protective structure.

### BRIEF DESCRIPTION OF THE DRAWINGS

FIG. 1 is a schematic view of a first embodiment of an RFID label.

FIG. 2 is a schematic view of a second embodiment of an RFID label.

FIG. 3 is a schematic view of a third embodiment of an RFID label.

FIG. 4 is a schematic view of a fourth embodiment of an RFID label.

FIG. 5 is a schematic view of a fifth embodiment of an RFID label.

### DETAILED DESCRIPTION OF THE INVENTION

Referring to FIG. 1, a first embodiment of a radio frequency identification (RFID) label includes an electronic tag 1, a first protective layer 2, a second protective layer 3, and a third protective layer 4. The third protective layer 4 is an embroidery layer. The first protective layer 2 is made of cloth. The second protective layer 3 is made of adhesive fabric, adhesive tape, or hot-melt adhesive tape. In manufacturing the RFID label, embroider on cloth to form patterns and/or figures. The electronic tab 1 is placed between the second protective layer 3 and the first protective layer 2. The first and second protective layers 2 and 3 tightly cling to each other via fusion or paste, to wrap the electronic tab 1 tightly between the first and second protective layers 2 and 3. The third protective layer 4 is attached to the first protective layer 2.

The (RFID) label of this embodiment is a semi-finished product. The first, second, and third protective layers 2, 3, and 4 form a protective structure. The electronic tab 1 is wrapped by the protective structure, to be protected well. The protective structure may be designed to form a termination product, such as a nameplate, a badge, a shoulder mark, a back patch, an armband, a chest card, or an ornament sheet, and so on, according to need. The second protective layer 3 of the RFID label may be combined with textiles including cloths, caps, trousers, shoes, socks, or be combined with cases and bags, via hot melt, glue, sewing, or pressing, and so on, according to kinds of the termination product.

In this embodiment, firstly, the RFID label is combined with the product, such as the nameplate, a badge, a shoulder mark, a back patch, an armband, a chest card, or an ornament sheet, consumers cannot easily know where is the RFID label, therefore, the RFID label is not easily damaged or taken off. Secondly, the RFID label is tightly combined with the product, the RFID label is not easily to be taken off if the product is not destroyed, therefore, the RFID label has functions of anti-fake, and prevention of theft. Furthermore, the RFID label also has a function of identifying ownership of the product.

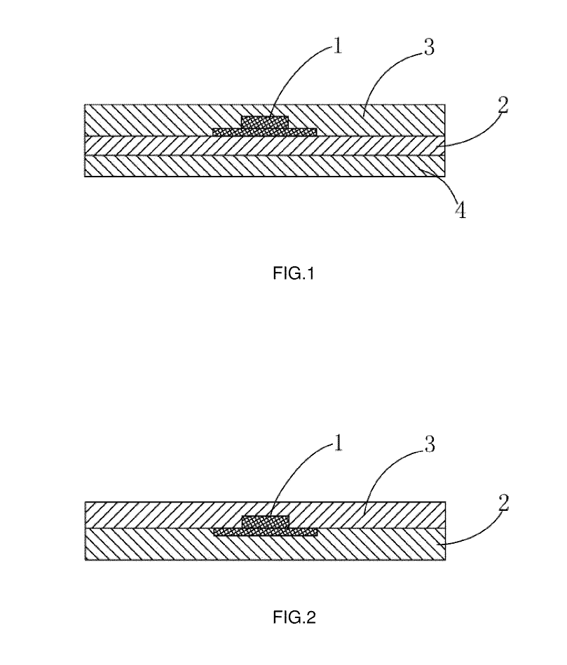

Referring to FIG. 2, a second embodiment of a radio frequency identification (RFID) label includes an electronic tag 1, a first protective layer 2, and a second protective layer 3. The first protective layer 2 is made of cloth. The second protective layer 3 is an embroidery layer. In manufacturing the RFID label, the first protective layer 2 and the second protective layer 3 form a protective structure, to wrap the electronic tag 1 therebetween. The protective structure may be designed to form a termination product, such as a nameplate, a badge, a shoulder mark, a back patch, an armband, a chest card, or an ornament sheet, and so on, according to need. The first protective layer 2 may be combined with textiles including cloths, caps, trousers, shoes, socks, or be combined with cases and bags, via hot melt, glue, sewing, or pressing, and so on.

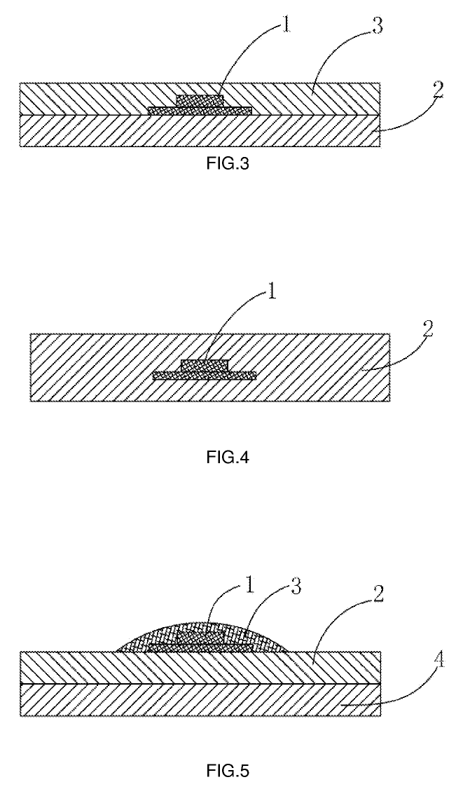

Referring to FIG. 3, a third embodiment of a radio frequency identification (RFID) label includes an electronic tag 1, a first protective layer 2, and a second protective layer 3. The first protective layer 2 is made of leather, rubber, or plastic, to form a product, such as a nameplate, a badge, a shoulder mark, a back patch, an armband, a chest card, or an ornament sheet, and so on, according to need. The electronic tab 1 is attached to a back of the first protective layer 2. The second protective layer 3 is attached to the first protective layer 2, to sandwich wrap the electronic tag 1 between the first and second protective layers 2 and 3. The first protective layer 2 and the second protective layer 3 form a protective structure, to wrap the electronic tag 1 therebetween. The second protective layer 3 is made of adhesive fabric, adhesive tape, or hot-melt adhesive tape. The second protective layer 3 may be combined with textiles including cloths, caps, trousers, shoes, socks, or be combined with cases and bags, via hot melt, glue, sewing, or pressing, and so on.

Referring to FIG. 4, a fourth embodiment of a radio frequency identification (RFID) label includes an electronic tag 1 and a first protective layer 2. The first protective layer 2 is made of rubber or plastic, to form a product, such as a nameplate, a badge, a shoulder mark, a back patch, an armband, a chest card, or an ornament sheet, and so on, according to need. Before the RFID label is molded, the electronic tab 1 is accommodated in the first protective layer 2. Therefore, the first protective layer 2 forms a protective structure to wrap the first protective layer 2 alone. In one embodiment, the first protective layer 2 includes two rubber or plastic sheets to sandwich the electronic tab 1 therebetween. The two rubber or plastic sheets are combined via glue or ultrasonic jointing, to form the first protective layer 2. In other embodiments, the first protective layer 2 may be injection molded via epoxide resin, and the electronic tab 1 is packaged in the first protective layer 2. The first protective layer 2 may be combined with textiles including cloths, caps, trousers, shoes, socks, or be combined with cases and bags, via hot melt, glue, sewing, or pressing, and so on.

Referring to FIG. 5, a fifth embodiment of a radio frequency identification (RFID) label includes an electronic tag 1, a first protective layer 2, a second protective layer 3, and a third protective layer 4. The first protective layer 2 is made of cloth or a rubber sheet. The second protective layer 3 is made of epoxide resin. The third protective layer 4 is an embroidery layer. In manufacturing the RFID label, embroider on the cloth or the rubber sheet and the embroidery layer to form patterns and/or figures. The cloth or rubber sheet and the embroidery layer may be designed to form a termination product, such as a nameplate, a badge, a shoulder mark, a back patch, an armband, a chest card, or an ornament sheet, and so on, according to need. The electronic tab 1 is placed on the cloth or rubber sheet. Epoxide resin is spread on the electronic tab 1, to wrap the electronic tab 1 together with the cloth or rubber sheet, therefore forming the RFID label. The RFID label may be combined with textiles including cloths, caps, trousers, shoes, socks, or be combined with cases and bags, via hot melt, glue, sewing, or pressing, and so on.

Furthermore, the RFID label may be attached to cuffs of jackets, collars, or supporting sheets supporting the cuffs or collars. The electronic tab 1 is packaged on a corresponding supporting sheet. The supporting sheet is made of one of paper, rubber, and non-woven fabrics.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

We claim:

1. A radio frequency identification (RFID) label for a product, the RFID label comprising:
a protective structure configured to be attached to the product; and
an electronic tag wrapped in the protective structure.

2. The RFID label of claim 1, wherein the protective structure is capable of being attached to the product via hot melt, glue, sewing, or pressing.

3. The RFID label of claim 1, wherein the protective structure comprises a first protective layer and a second protective layer, the electronic tab is wrapped between the first and second protective layers.

4. The RFID label of claim 3, wherein the first protective layer is made of cloth, the second protective layer is an embroidery layer.

5. The RFID label of claim 3, wherein the first protective layer is a leather sheet, a rubber sheet, or a plastic sheet; the second protective layer is made of adhesive fabric, adhesive tape, or hot-melt adhesive tape.

6. The RFID label of claim 1, wherein the protective structure comprises a first protective layer, a second protective layer, and a third protective layer; wherein the first to third protective layers are stacked together, the electronic tab is wrapped between the second and third protective layers.

7. The RFID label of claim 6, wherein the first protective layer is an embroidery layer, the second protective layer is made of cloth, the third protective layer is made of adhesive fabric, adhesive tape, hot-melt adhesive tape, or epoxide resin.

8. The RFID label of claim 1, wherein the protective structure comprises a first protective layer, a second protective layer, and a third protective layer; wherein the first to third protective layers are stacked together, the electronic tab is wrapped between the first and second protective layers.

9. The RFID label of claim 8, wherein the first protective layer is made of rubber sheet or cloth, the second protective layer is made of poxide resin, the third protective layer is an embroidery layer.

10. The RFID label of claim 1, wherein the protective structure forms one of a nameplate, a badge, a shoulder mark, a back patch, an armband, a chest card, and an ornament sheet.

11. The RFID label of claim 1, wherein protective structure is configured to be attached to a supporting sheet that is made of one of paper, rubber, and non-woven fabric, for supporting a cuff or a collar of a jacket; wherein the electronic tab is wrapped by the supporting sheet and the protective structure.
